(19) United States
(12) Patent Application Publication
(10) Pub. No.: US 2002/0160133 A1
(43) Pub. Date: Oct. 31, 2002

(54) Food pan cover with an elastomeric seal

(76) Inventors: Ruane S. Jeter, Los Angeles, CA (US); Charles W. Jarvis, Irvine, CA (US)

Correspondence Address: George F. Bethel, Suite 230, 180 Newport Center Drive, Newport Beach, CA, 92660-6972, US

(21) Appl. No.: 09/842,080

(22) Filed: Apr. 25, 2001

(51) Int. Cl. B32B 23/02; B65D 6/08; B32B 1/02

(52) U.S. Cl. 428/35.7; 428/192; 220/669; 428/34.1

(57) ABSTRACT

A food pan cover for use with a food pan having a flange extending from the walls and substantially surrounding the periphery of the walls. A plurality of protuberances and depressions are formed on the underside of the flange; on the cover under and adjacent to the walls, and a plurality of dovetail members are formed on the periphery of the walls. An elastomeric seal is formed on the protuberances, and depressions and dovetails of a polyurethane having a usable temperature after molding of 212° fahrenheit and a hardness of 60 to 120 shore A, with a plurality of ribs, and terminates in a downwardly curved projection defining a groove around the periphery of the seal.

### BACKGROUND OF THE INVENTION

1. Field of the Invention

The field of this invention resides within the food pan art. In particular, it resides within the food pan art with respect to institutional food service such as in restaurants, schools, hospitals, and hotels that rely upon storage of food in a well maintained container. More specifically, it resides within the plastic food pan art related to sealing plastic food containers where the lid or cover can be removed and replaced over an extended period of time in order to maintain pure and clean food for service.

2. Prior Art of this Invention

The prior art with regard to food pans for food service relates to food pans having covers. Such food pans with a covers, are utilized for restaurants, fast food service, hotels, banquet facilities, hospitals, schools, and prisons. When referring to food pans of this invention as to the prior art, the general prior art is relevant with regard to food pans which are made of plastic with covers thereover.

When reviewing the prior art food pans that are made of plastic with covers thereover, it is seen that certain food pans are made with a lid or cover with a flange, groove, or other means for sealing the cover to a food pan. The sealing of such covers to a food pan is such wherein the resiliency of the plastic is utilized for engaging the cover with regard to such structures as flanges, grooves, and related seals.

In the utilization of seals such as flanges and grooves, or other catching means, a sufficiently tight seal is usually not maintained. This is because of the fact that the nature of the plastic will not yield sufficiently to allow for a close proximate sealing of the food pan with the cover thereover. As a consequence, the cleanliness, integrity, and maintenance of the food can not be provided without a degree of possible contamination.

This invention specifically incorporates an elastomeric seal which is preferably affixed, secured, bonded or molded to the cover or lid. The elastomeric seal when secured or bonded to the cover or lid is such where it can be placed on the pan and retained in a tightened sealed relationship.

Alternately, the elastomeric seal can be bonded to the pan so that the cover or lid can be placed on the pan and retained in a tightly sealed manner.

The elastomeric nature allows for a flexing and tightly juxtaposed fitting of the cover or lid on the pan. This helps to accommodate a seal which prevents intrusion of contaminants and foreign substances which are deleterious to the food once prepared.

It should be understood that the food once prepared is oftentimes retained for an extended period of time either in a heated or semi-heated condition or in the alternative a cooled condition. Thus, a desire to eliminate contaminants in the pan with the cover or lid thereover is extremely well sought after. However, there has not been a superior solution in the prior art for such seals to prevent food contamination within the pan.

This invention provides for an elastomeric seal on a cover or lid or on a pan which is compatible with food and at the same time seals the cover or lid and pan together in a firm manner to substantially eliminate contamination.

### SUMMARY OF THE INVENTION

In summation, this invention comprises a food pan and a cover or lid with an elastomeric seal having various portions which are firmly fixed to the cover or pan which respectively seat within a food pan or cover for sealing thereof.

More specifically, the invention comprises a food pan and cover having an elastomeric seal. The elastomeric seal has plural flanges externally surrounding the cover or pan. One of the flanges incorporates a substantially concave portion which flexes inwardly to allow for a flexibly improved seal.

Further to this extent, the cover with the pan provides for a seal which is retained in a tightened condition over an extended period of time. This elastomeric seal is based upon utilization of plastics which are compatible with the food pan and cover while at the same time being acceptable for food service.

The cover or pan has numerous indentations, openings, and notches for receipt of the molded elastomeric seal. The seating of the elastomeric seal and affixing, securing, bonding, or molding to the cover or pan is enhanced so that the configuration of the notches and openings allow for a mechanical retention of the seal. Also, the seal is most preferably of a chemical composition which is compatible with the plastic material to which it is secured or molded.

The net result is to provide a seal which is compatible and molded or otherwise secured to the plastic cover or to the pan while at the same time being held and supplemented for retention by grooves, notches and openings for the securement thereof on the cover or pan respectively.

### BRIEF DESCRIPTION OF THE DRAWINGS

FIG. 1 shows a perspective view of the food pan and cover overlying the pan showing the elastomeric seal surrounding it.

FIG. 2 shows a perspective view of the cover partially in place and partially withdrawn from the pan.

FIG. 3 shows a fragmented side elevation view of the cover prior to receiving by molding the elastomeric seal thereto.

FIG. 4 shows a fragmented side elevation view of the cover after the seal has been bonded thereto.

FIG. 5 shows a bottom plan view looking upwardly at the corner of the cover prior to the elastomeric seal being molded thereto.

FIG. 6 shows a sectional view in the direction of lines 6-6 of FIG. 5.

FIG. 7 shows a sectional view through lines 7-7 of FIG. 4 wherein the elastomeric seal is shown bonded to the cover.

FIG. 8 shows a sectional view of the seal of FIG. 7 as it is emplaced and held by the side walls of the pan.

FIG. 9 shows an enlarged detailed plan view of the dovetailed edges of the pan with the specific under cuts and draft lines as well as other relieved and protruding portions.

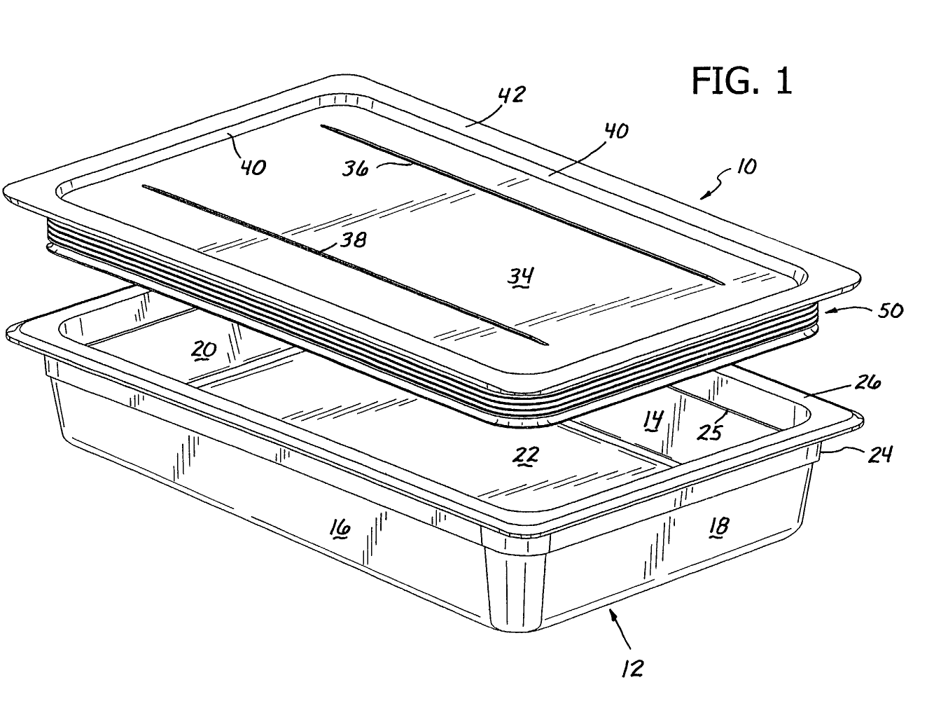

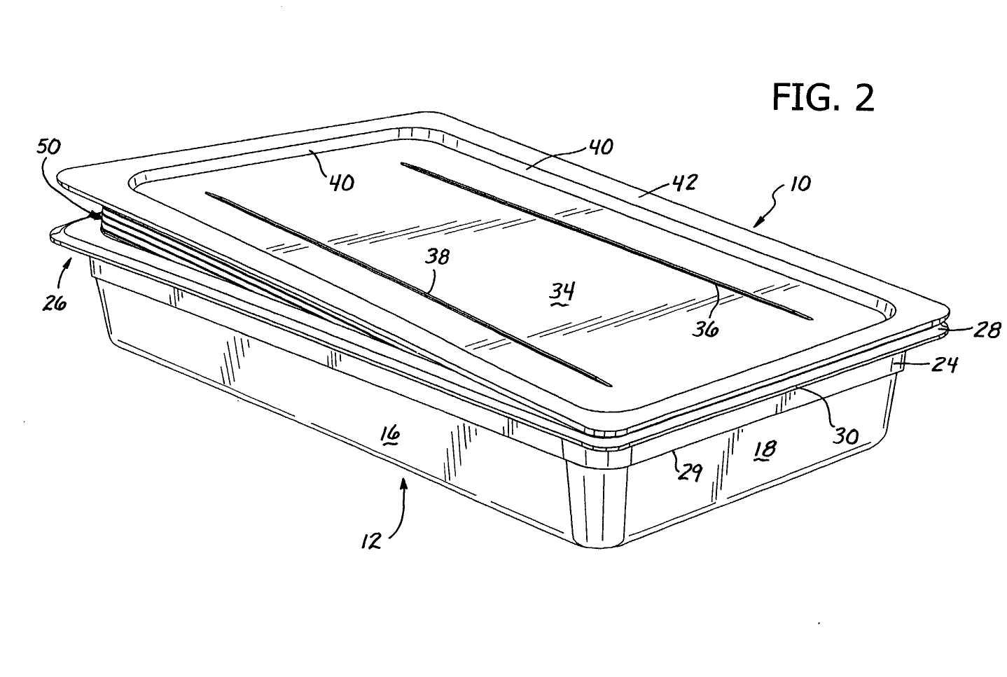

### DESCRIPTION OF THE PREFERRED EMBODIMENTS

While the invention is primarily described with respect to the preferred embodiment wherein the elastomeric seal is adhered, secured, bonded or molded onto the lid or cover for sealing with the pan, it should be understood that the invention is also intended to include placement of the elastomeric seal on the pan for sealing with the cover.

Looking more specifically at the figures, it can be seen that the invention comprises a cover or lid 10 which is suitable for placement over, and substantially in sealed relationship with a pan or dish 12. The pan 12 has exterior side walls 14 and 16 with end walls 18 and 20. These respective walls 14, 16, 18, and 20 define a bottom portion 22.

The walls 14 through 20 terminate upwardly into an area that is set outwardly of the edge by a band or bead 24. The band or bead 24 can be seen in FIG. 8. The band 24 has an interior stepped area 25 having an interiorly flared surface 27 which tapers into the band 24 and the wall 18 and has an outward step 29.

The band or bead 24 as stepped from the walls 14 through 20 also provides reinforcement. On the top edge of the pan 12 a flange or web 26 is provided which circumscribes the pan 12. The flange or web 26 has a compound curved portion 28 providing a concavity which terminates at the edge region in a lip 30 circumscribing the pan 12.

The reinforced edge or band 24 serves to provide for a degree of strength as well as receiving the seal of the cover 10. This strength enhances the overall features to allow for a seal to be maintained by avoiding untoward flexure outwardly. The flange 26 with the lip 30 also reinforces the edge region while at the same time providing a seating surface upon which the cover 10 can be placed. The depending or lowered lip 30 allows a space between the cover 10 and the pan for gripping and removing of the cover.

Looking more specifically at the cover 10, it can be seen that a top portion 34 is provided with ribs 36 and 38 which help to provide rigidity. The top portion 34 of the cover 10 is recessed, indented or depressed by virtue of a wall 40 surrounding the interior portions. The wall 40 extends upwardly to a surrounding lip, flange, or edge region 42. The upper lip or flange 42 is spaced upwardly from the surface of the top 34 by the distance of the wall 40.

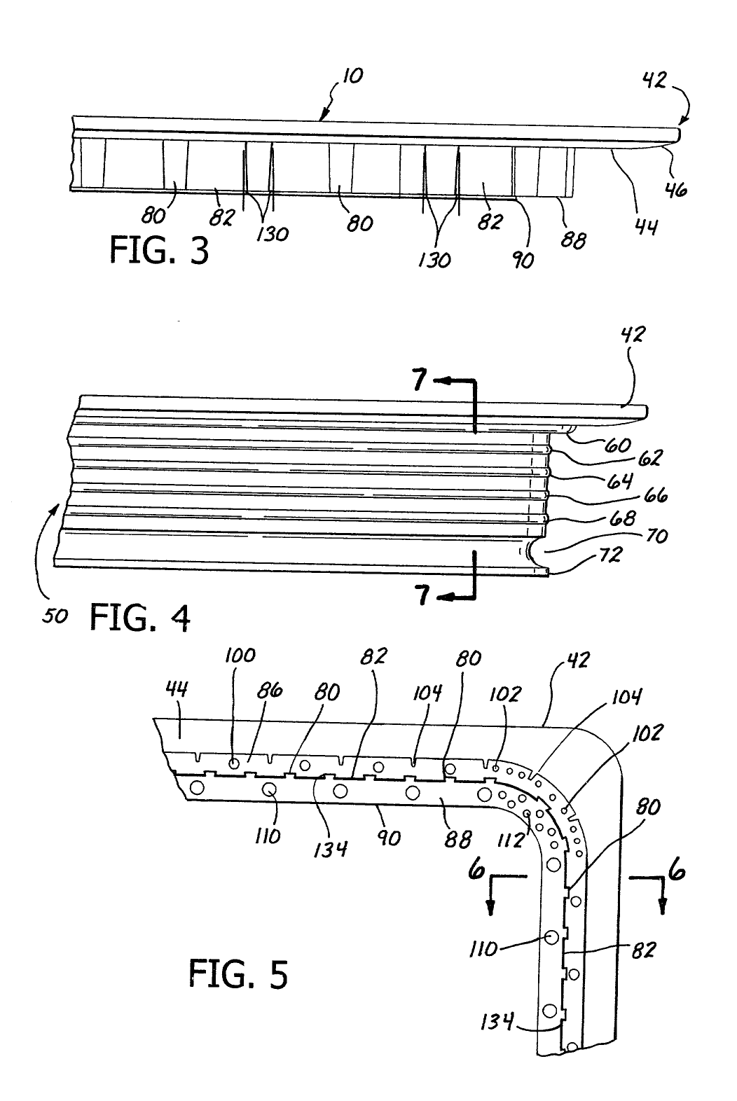

As shown in FIG. 3, the flange or edge region 42 has an underside or lower portion 44 which tapers at a tapered region 46 in order to fair into the edge of the flange 42. This slightly tapered portion allows for removal of the cover 10 in a more facile manner by providing for a grip.

In order to secure the cover 10 in a relatively and substantially sealed condition to the pan 12, a seal, gasket, or closure 50 is provided around the edge of the cover 10. This seal, gasket or closure 50 is flexible and extends downwardly below the major portion of the cover 10. The seal 50 is sufficiently flexible as can be seen in FIGS. 7 and 8 to permit the placement of the seal 50 interiorly of the pan 12.

Looking more specifically at FIG. 8, it can be seen wherein the seal 50 is displaced slightly inwardly to the point of sealing the cover 10 to the pan 12 at the interface thereof. This interface shows wherein the band 24 is reduced at a step 25 which has a tapered surface 27 circumscribing the interior portion of the pan 12.

The seal 50 is in the form of an elastomeric material which is preferably a thermoplastic polyurethane as provided by Bayer Corporation Plastics Division. An aromatic polyether-based elastomeric plastic or other elastomeric plastic meeting the requirements which will be set forth hereinafter can also be used.

When adhering, bonding and molding the seal 50 to the cover 10, the bond is made preferably to a polycarbonate which provides for a strong bond, particularly when a thermoplastic polyurethane is the material of the seal. However, other types of plastics other than a polycarbonate for the cover 10 and for the pan 12 can be utilized. The substitution of various materials for the seal 50 will be expanded upon hereinafter.

Looking more specifically at the seal 50, it can be seen where it comprises an interior expanded lip or flange portion 60 which has been molded around the edge as seen in FIGS. 4, 7, and 8. This molded edge portion seats within a recess as will be detailed hereinafter within the cover 10. The seal 50 has a plurality of longitudinal ribs or protruding bands 62, 64, 66, and 68. The protruding bands 62 through 68 although four in number can be of other plural numbers depending upon the amount of resiliency seal and tightness that is required in seating the cover 10 within the pan 12. In some measure, these ribs or circumscribing bands 62 through 68 can be seen in a relatively collapsed condition when sealed as shown in FIG. 8.

Circumscribing the seal 50 at the base portion thereof is a convex arcuate trough 70 with a terminal edge portion extension or finger 72. The arcuate portion 70 is preferably outside of the general line or dimension extending downwardly along the edge of the seal defining the area between the ribs 62 through 68. In this manner, when impressed into the pan 12 interior, it can be seen as collapsing inwardly to provide a seal in conjunction with the rounded or sloped edge 27 of the step 25 surrounding the interior of the pan 12. This substantially helps to seal the interface between the seal 50 and the pan 12.

Various configurations to provide the arcuate convex configuration 70 terminating in the terminal portion 72 can be utilized. In effect, it can constitute a protuberance, rib, finger, expansion, or land 80 which flexes inwardly and outwardly in its cross-section. The finger or extension 80 when displaced by the side walls of the pan 12 creates somewhat of a seal. As can be seen in FIG. 8, the inward flexure creates an up bending channelized portion 72 which creates an improved seal with significant resilience as well as sealing continuity.

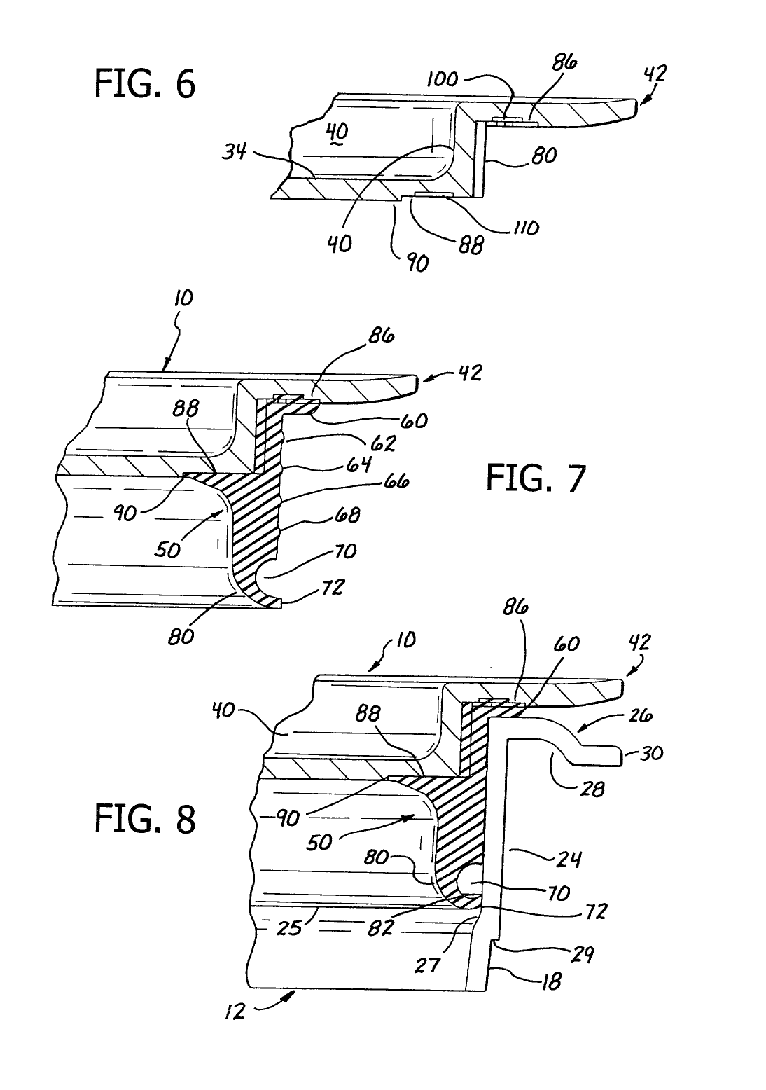

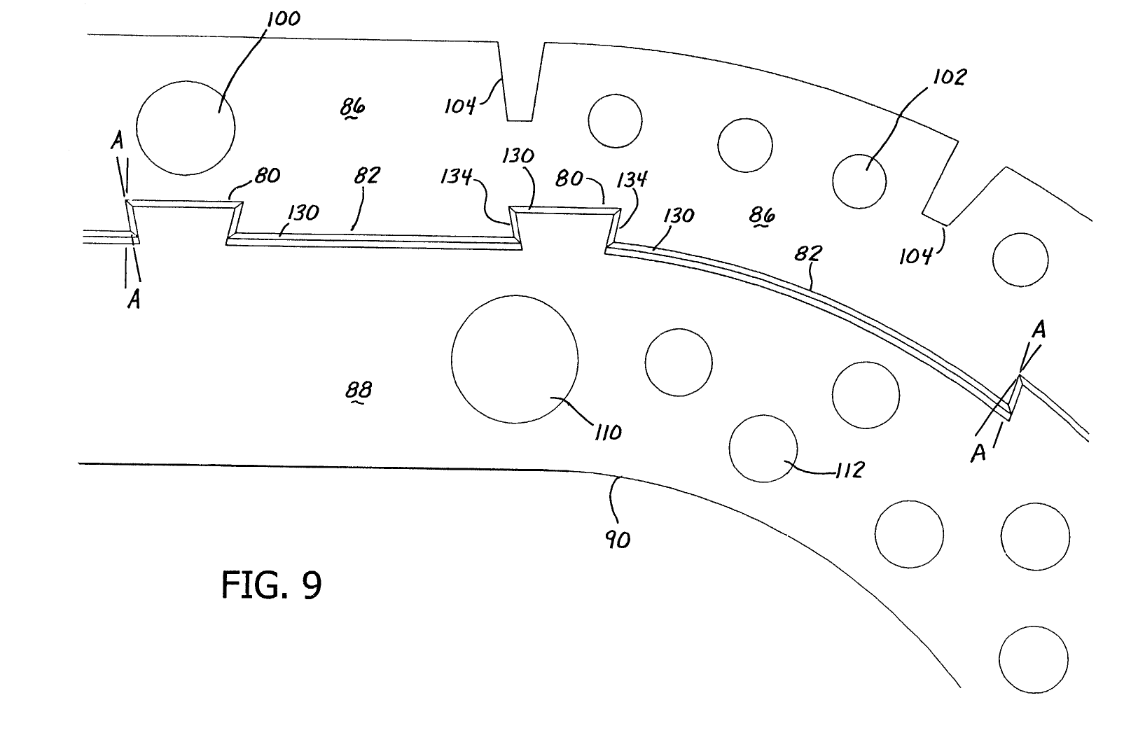

Looking more specifically at the cover 10 without the seal 50, it can be seen that the cover 10 in FIGS. 3, 5, 6 and 9 has been shown in detail. A plan view of the underside of the seal 50 has been shown in FIG. 5 with a highly enlarged view as taken within a curved portion of the bottom of the cover 10 in FIG. 9.

The cover 10 without the seal as seen in FIG. 3 shows the lip 42 having its sloped faired portion 46 terminating in the lower edge 44. Extending therefrom are a number of dovetail like portions 80. The dovetail like portions 80 are such where they extend downwardly toward the lower portion of the cover. The dovetails 80 are relieved between them with relief portions, insets, indentations, depressions, and channels 82 between the dovetails. The insets 82 are configured so as to provide for a gripping of the seal in the manner to be described.

As shown in FIG. 5, the upper portion of the dovetails 80 and relief portions 82 terminate in a channel 86 formed as a slight depression on the underside 44 of the flange 42 for receiving the seal 50 therein. In the lower area, the dovetails 80 terminate at an interior portion, or relieved surface forming a shallow channel 88 with a step 90 surrounding the interior periphery or underside of the top portion 34 of the cover 10. This channel 88 with the step 90 allows for a retention of the seal 50 in a more secure position than without it.

Enhancing the overall mechanical adhesion of the seal 50 to the cover 10 are a plurality of circular depressions 100 in the channel 86 and relatively smaller depressions 102. Also, a plurality of angular tabs or insets 104 can be seen. The angular tabs or insets 104 allow for a further gripping of the seal 50.

On the interior channel 88 with the step or ledge 90, it can be seen that there is a second grouping of round depressions 110 and smaller depressions 112. These respective depressions 110 and 112 allow for a further griping of the seal 50.

When the top or cover 10 without the seal 50 is first injection molded, or formed in any other particular way it must be withdrawn from the mold. Accordingly, a draft angle 130 can be seen on the insets 82 and the dovetails 80 as shown in FIG. 3. This draft angle 130 can be a reduction in exterior dimensions. As the part is withdrawn from the mold, it comes off freely without binding on the mold. The draft angle can be anywhere from 1° to 9° or more depending upon the type of mold.

In order to provide for a dovetail mechanical engagement of the seal 50 into the insets 82 and the dovetails 80, the dovetails have an angular inset 134 which creates a grip on the seal 50. This angle can be approximately anywhere from 1° to 30° from where it intersects the peripheral arch of the inset 82 and the edge of the inset along the periphery. This angle A can be seen in FIG. 9 as expanded upon and is the angle which helps to mechanically secure the seal 50.

The draft angle 130 of the edge region, and the insets 82 and dovetails 80, can be seen in FIG. 3. This further enhances the withdrawal of the cover 10 from the mold.

When the seal 50 is molded in place, the draft angle 130 of the edge region provides for a tightened relationship on the mechanical interface between the round openings 100, 102, 110 and 112. Also, the stepped relationship of the seal 50 on the indentations 82 and the dovetails 80 with the notches 134 provides for a locking and securement of the seal. Accordingly, a mechanical linkage takes place between the cover 10 and the seal 50.

In order to enhance the linkage, the elastomeric material forming the seal 50 is preferably chemically compatible with the plastic forming the pan 12 and the cover 10. For example, when the cover 10 is made from a polycarbonate, then the seal 50 is preferably made from a thermoplastic polyurethane generally referred to as an aromatic polyether-based grade polyurethane plastic.

This combination of a polycarbonate lid and a polyurethane elastomer seal 50 provides a bond with a great degree of adhesion. The polyurethane elastomer with its resilience and bonding capacity to the polycarbonate provides for a strong bond while at the same time a significant flexibility for sealing as seen in the cross-section of FIG. 8.

In order to provide for sufficient flexibility, a shore A rating of between 60 and 120 of the finally molded seal 50 should be provided. This provides sufficient sealing, resilience and deformation for allowing the seal to resiliently deform while at the same time maintaining sufficient stiffness to provide a seal.

The plastic material for the seal 50 which is most preferred is an aromatic polyether-based thermoplastic polyurethane sold by Bayer Corporation Plastics Division under the mark TEXIN®. TEXIN® is an aromatic polyether-based polyurethane. It can be processed by injection molding, extrusion or blow molding. The resin exhibits an inherent resistance to hydrolysis and the attack of fungi and provides abrasion resistance and impact strength with flexibility.

Polyetherimides such as ULTEM® provided by General Electric can also be utilized for the seal 50. This polyetherimide material provides a high level of heat resistance, chemical resistance, high dielectric strength, good mechanical properties and ease of fabrication coupled with good bonding ability.

The use of TEXIN® for the seal 50 with polycarbonate for the cover 10 and the pan 12 is helpful in complying with FDA, NSF, USDA, and SPSC regulations for food service. This being the case, health and safety for the food service is maintained.

Inasmuch as the pan 12 and cover 10 of this invention must be food compatible and meet with FDA food-contact regulations, polycarbonate is deemed desirable and is well received. Polycarbonate is further desirable because of its clarity.

Other preferred plastics for the food pan 12 and the cover 10 can be utilized. For example, other preferred plastics for the food pan 12 and for the cover 10 include among others polyethylenes, polypropylenes, and styrenic resins, in particular, styrene-acrylonitrile (SAN) and acrylonitrile-butadiene-styrene (ABS). The above mentioned plastics or resins are preferred for their clarity, ease of fabrication, thermal stability, relatively high modulus and low cost.

The food pan 12, the cover or lid 10 and the seal 50 according to the invention can be made from many other plastic materials besides those preferred plastic materials mentioned above. When intended for food use, any of the resins and polymers approved for food use by the Food and Drug Administration can be used keeping in mind that chemically compatible material provide a better bond. Examples of such plastic materials can include among others the homopolymers, copolymers, polymers and mixtures thereof containing:

Acrylic and modified acrylic plastics;

Acrylonitrile/butadiene/styrene copolymers;

Acrylonitrile/butadiene/styrene/methyl methacrylate copolymers;

Acrylonitrile/styrene copolymers;

Acrylonitrile/styrene copolymer modified with butadiene/styrene elastomers;

n-Alkylglutarimide/acrylic copolymers;

Cellophanes;

Cross-linked polyacrylate copolymers;

1,4-Cyclohexylene dimethylene terephthalate and 1,4-Cyclohexylene dimethylene isophthalate copolymers;

Ethylene-acrylic acid copolymers;

Ethylene-carbon monoxide copolymers.

Ethylene-1, 4-cyclohexylene dimethylene terephthalate copolymers;

Ethylene-ethyl acrylate copolymers.

Ionomeric resins;

Ethylene-methyl acrylate copolymer resins;

Ethylene/1,3-phenylene oxyethylene isophthalate/terephthalate copolymers;

Ethylene-vinyl acetate copolymers;

Ethylene-vinyl acetate-vinyl alcohol copolymers;

Fluorocarbon resins;

Isobutylene polymers;

Isobutylene-butene copolymers;

Melamine-formaldehyde resins;

Nitrile rubber modified acrylonitrile-methyl acrylate copolymers;

Nylon resins;

Olefin polymers;

Perfluorocarbon resins;

Polyarylate resins;

Polyaryletherketone resins;

Polyarylsulfone resins;

Poly-1-butene resins and butene/ethylene copolymers;

Polycarbonate resins;

Polyestercarbonate resins;

Polyester elastomers;

Polyetherimide resins;

Polyethylene resins, carboxyl modified;

Polyethylenes, chlorinated;

Polyethylenes, fluorinated;

Polyethylenes, oxidized;

Polyethylene phthalate polymers;

Poly(phenyleneterephthalamide)resins;

Poly(p-methylstyrenes) and rubber-modified poly(p-methylstyrenes);

Poly(oxy-1,2-ethanediyloxycarbonyl-2,6-naphthalenediylcarbonyl) resins;

Polystyrenes and rubber-modified polystyrenes;

Polysulfide polymer-polyepoxy resins;

Polysulfone resins;

Poly(tetramethylene terephthalates);

Polyurethane resins;

Styrene block polymers;

Styrene-maleic anhydride copolymers;

Styrene-methyl methacrylate copolymers;

Textryls;

Urea-formaldehyde resins;

Vinyl chloride-ethylene copolymers;

Vinyl chloride-hexene-1 copolymers;

Vinyl chloride-lauryl vinyl ether copolymers;

Vinyl chloride-propylene copolymers;

Vinylidene chloride/methyl acrylate copolymers; and,

Vinylidene chloride/methyl acrylate/methyl methacrylate polymers.

The above list is only intended to be illustrative of the plastics which can be used and is not intended to constitute a limitation thereof. Other plastic materials and mixtures thereof will be apparent to one skilled in the art and can be used without departing from the spirit and scope of the invention.

In addition to the foregoing, food is sometimes served at elevated temperatures. Accordingly, preferred elastomers and plastics including polycarbonates should have a temperature of deformation which is greater than or equal to about 212° fahrenheit. In most uses, the foregoing elastomers as noted are such where they exceed the temperature requirements for food service.

Based upon the foregoing, it can be seen that this invention is a substantial step over the prior art in providing a sealed relationship between a cover 10 that can be easily removed yet provide a sufficient seal over a pan 12 containing food which is to be served.

1. A plastic food pan cover comprising:
a cover having a top major surface;
at least one upright wall surrounding said major surface;
an elastomeric seal adhered to the exterior of said wall;
a plurality of retention projections extending from said wall to mechanically enhance bonding between said wall and said seal; and,
at least one rib forming a portion of said seal for sealing between said cover and a food pan.

2. A plastic food pan cover as claimed in claim 1 wherein:
said at least one rib forming a portion of said seal is formed in a plurality of ribs.

3. A plastic food pan cover as claimed in claim 2 wherein:
said at least one wall defining said major surface of said cover is formed as a depressed surface.

4. A plastic food pan cover as claimed in claim 1 wherein:
said retention projections extending from said wall are formed as dovetails.

5. A plastic food pan cover as claimed in claim 4 further comprising:
a flange extending from said walls; and,
a plurality of indentations on the surface of said flange and wherein said seal is molded onto said retention projections of said walls and onto said indentations on said flange.

6. A plastic food pan cover as claimed in claim 5 further comprising:
a plurality of indentations on the interior surface of said cover proximate said wall within which said seal can be molded.

7. A plastic food pan cover as claimed in claim 1 wherein:
said seal has a groove substantially surrounding the periphery thereof formed by a terminal extension of said seal.

8. A plastic food pan cover as claimed in claim 7 wherein:
said seal is formed from an aromatic polyether-based polyurethane and said cover is formed from a polycarbonate.

9. A plastic food pan cover as claimed in claim 8 wherein:
said seal has a usable temperature after molding of at least 212° fahrenheit and a shore hardness in the range of 60 to 120 shore A.

10. The combination of a food pan and cover comprising:
a food pan having side walls, a bottom, and a flange extending around the upper periphery of the walls;
a cover having a major surface and side walls extending upwardly from said major surface;
a plurality of protuberances and depressions formed on the outer region of said cover side walls; and,
a seal molded to the edge region of said cover formed with a plurality of ribs substantially surrounding said seal wherein said seal fits into the interior of said pan to extend downwardly and flex inwardly.

11. The combination as claimed in claim 10 further comprising:
a terminal extension of said seal having a groove surrounding it and a flexible portion extending from the edge region of said groove.

12. The combination as claimed in claim 10 wherein:
said seal is molded to said cover and is formed of a polyurethane; and,
said cover is made of a polycarbonate.

13. The combination as claimed in claim 12 wherein:
said cover has a flange extending around said periphery and a plurality of depressions and protuberances are formed on said flange into which said seal is molded.

14. The combination as claimed in claim 10 further comprising:
dovetail like projections extending from the outer portion of said cover side walls on which said seal is molded.

15. The combination as claimed in claim 14 wherein:
said seal is formed of a polyurethane; and,
said cover is formed of a polycarbonate.

16. A food pan cover comprising:
a cover formed with a major upper surface with walls extending upwardly therefrom;
a flange extending from the walls and substantially surrounding the periphery of said walls;
a plurality of protuberances and depressions formed on the underside of said flange;
a plurality of protuberances and depressions formed under said cover and adjacent to said walls;
a plurality of dovetail members formed on the periphery of said walls; and,
an elastomeric seal formed on said protuberances and
depressions and dovetail members.

17. The cover as claimed in claim 16 wherein:
said seal is formed of a polyurethane having a usable temperature after molding of 212° fahrenheit and a hardness of 60 to 120 shore A.

18. The cover as claimed in claim 16 wherein:
said seal is formed with a plurality of ribs; and,
said seal terminates in a downwardly curved projection defining a groove around the periphery of said seal.

19. A food container cover and seal comprising:
a cover formed with a major surface surrounded by an upstanding wall and terminating at its periphery with a flange;
a plurality of protuberances extending from said wall with relieved portions therebetween;
a seal bonded to said cover on said protuberances formed of an elastomeric material having a hardness of 60 to 120 shore A and a temperature resistance when in use after molding at or exceeding 212°; and,
a plurality of ribs surrounding and formed on said seal.

20. The food container cover as claimed in claim 19 wherein:
said cover is formed of a polycarbonate and said seal is formed of a polyurethane which is injection molded and bonded to said polycarbonate.

21. The food container cover as claimed in claim 19 further comprising:
channels formed on the underside of said flange and on said major surface proximate said wall into which said seal is molded.

22. The food container cover as claimed in claim 21 further comprising:
recesses in said respective channels into which said seal is molded.

23. The food container cover as claimed in claim 19 further comprising:
a terminal extension of said seal formed with a groove therein.
